(19) United States
(12) Patent Application Publication
(10) Pub. No.: US 2015/0192546 A1
(43) Pub. Date: Jul. 9, 2015

(54) CONTROL OF ENTITIES SUCH AS DROPLETS AND CELLS USING ACOUSTIC WAVES

(71) Applicants: President and Fellows of Harvard College, cambridge, MA (US); Universität Augsburg, Augsburg (DE)

(72) Inventors: David A. Weitz, Bolton, MA (US); Thomas Franke, Augsburg (DE)

(21) Appl. No.: 14/408,675

(22) PCT Filed: Jun. 26, 2013
(86) PCT No.: PCT/US13/47829

§ 371 Date: Dec. 17, 2014

Related U.S. Application Data
(60) Provisional application No. 61/665,087, filed on Jun. 27, 2012.

(51) Int. Cl. G01N 29/02

(52) U.S. Cl. CPC G01N 29/02

(57) ABSTRACT

The present invention generally relates to manipulation of entities using acoustic waves. For example, by applying acoustic waves to a surface containing entities such as particles, cells, droplets, etc., the entities may be manipulated in various ways on the surface. The surface acoustic waves may be created using a surface acoustic wave generator such as an interdigitated transducer, and/or a material such as a piezoelectric substrate. In some cases, two or more acoustic waves may be applied, and the waves may interfere to create standing waves. The standing waves can be manipulated to manipulate the entities on the surface. For instance, the frequencies of the surface acoustic waves may be slightly mismatched to cause travelling standing waves to occur, which may be used to align the entities.

### RELATED APPLICATIONS

This application claims the benefit of U.S. Provisional Patent Application Ser. No. 61/665,087, filed Jun. 27, 2012, entitled “Control of Entities Such as Droplets and Cells Using Acoustic Waves,” by Weitz, et al., incorporated herein by reference in its entirety.

### FIELD OF INVENTION

The present invention generally relates to manipulation of entities using acoustic waves.

### BACKGROUND

The manipulation of fluids to form fluid streams of desired configuration, discontinuous fluid streams, droplets, particles, dispersions, etc., for purposes of fluid delivery, product manufacture, analysis, and the like, is a relatively well-studied art. Examples of methods of producing droplets in a microfluidic system include the use of T-junctions or flow-focusing techniques. However, improvements in such techniques are still needed.

### SUMMARY

The present invention generally relates to manipulation of entities using acoustic waves. The subject matter of the present invention involves, in some cases, interrelated products, alternative solutions to a particular problem, and/or a plurality of different uses of one or more systems and/or articles.

In one aspect, the present invention is generally directed to an apparatus. In accordance with one set of embodiments, the apparatus comprises a piezoelectric substrate, a first acoustic wave generator able to direct first acoustic waves at a target region of the piezoelectric substrate, and a second acoustic wave generator able to direct second acoustic waves at the target region of the piezoelectric substrate. In some cases, the apparatus further comprises a plurality of entities suspended in a fluid disposed proximate the piezoelectric substrate.

The invention, in another aspect, is directed to a method. The method, in one set of embodiments, includes acts of providing a plurality of entities in a fluid flowing at an average fluid velocity, and aligning at least some of the entities by applying a first acoustic wave and a second acoustic wave to at least a portion of the fluid, wherein the first acoustic wave and the second acoustic wave interfere to create a standing acoustic wave having a nodal propagation velocity within about 20% of the average fluid velocity.

In another set of embodiments, the method includes acts of determining an average velocity of plurality of entities suspended in a fluid, and applying a first acoustic wave and a second acoustic wave to at least a portion of the fluid. In some instances, the first acoustic wave and the second acoustic wave may have frequencies selected to interfere to create a standing acoustic wave having a nodal propagation velocity within 20% of the average velocity.

In another aspect, the present invention encompasses methods of making one or more of the embodiments described herein. In still another aspect, the present invention encompasses methods of using one or more of the embodiments described herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates one embodiment of the invention for aligning entities such as droplets on a surface;

FIGS. 2A-2D illustrate a travelling standing wave;

FIGS. 3A-3B illustrate alignment of beads on a surface in accordance with another embodiment of the invention; and

FIG. 4 illustrates a tapered interdigitated transducer for use in certain embodiments of the invention.

### DETAILED DESCRIPTION

The present invention generally relates to manipulation of entities using acoustic waves. For example, by applying acoustic waves to a surface containing entities such as particles, cells, droplets, etc., the entities may be manipulated in various ways on the surface. The surface acoustic waves may be created using a surface acoustic wave generator such as an interdigitated transducer, and/or a material such as a piezoelectric substrate. In some cases, two or more acoustic waves may be applied, and the waves may interfere to create standing waves. The standing waves can be manipulated to manipulate the entities on the surface. For instance, the frequencies of the surface acoustic waves may be slightly mismatched to cause travelling standing waves to occur, which may be used to align the entities.

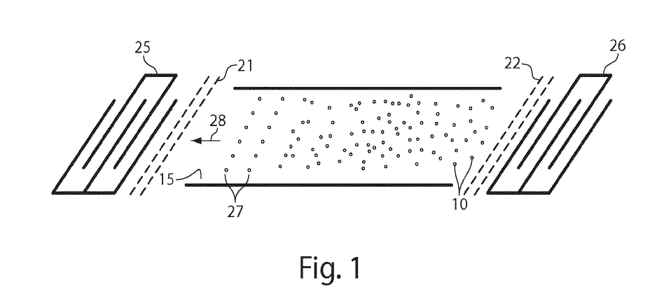

One example of an embodiment of the invention is now described with respect to FIG. 1. As will be discussed in more detail below, other configurations may be used as well in other embodiments. In FIG. 1, a plurality of entities 10 (e.g., particles, cells, droplets, etc.) on the surface of substrate 15 are subjected to first acoustic wave 21 and second acoustic wave 22, generated respectively by acoustic wave generators 25 and 26. In some cases, the plurality of entities may be carried in a fluid, as indicated by 28. The acoustic wave generators may comprise interdigitated transducers, or other suitable systems for producing acoustic waves, as discussed herein.

The frequencies of the first acoustic wave 21 and second acoustic wave 22 may be selected to create standing waves through interference, which may be used to manipulate the entities. For example, in one set of embodiments, their frequencies may be selected to be the same. The interference of these acoustic waves would create a standing wave having relatively stationary “nodes,” or points where essentially no net movement occurs. Accordingly, in one set of embodiments, the entities may be directed into certain regions on the substrate, e.g., at the stationary nodes.

In another set of embodiments, however, the frequencies of the acoustic waves may be selected to be slightly different from each other. For instance, their frequencies may be selected to be within about 10% or 5% of each other. Because their frequencies are not exactly the same, the location of the nodes created by the interference of the acoustic waves may shift with respect to time, at a speed called the nodal propagation velocity.

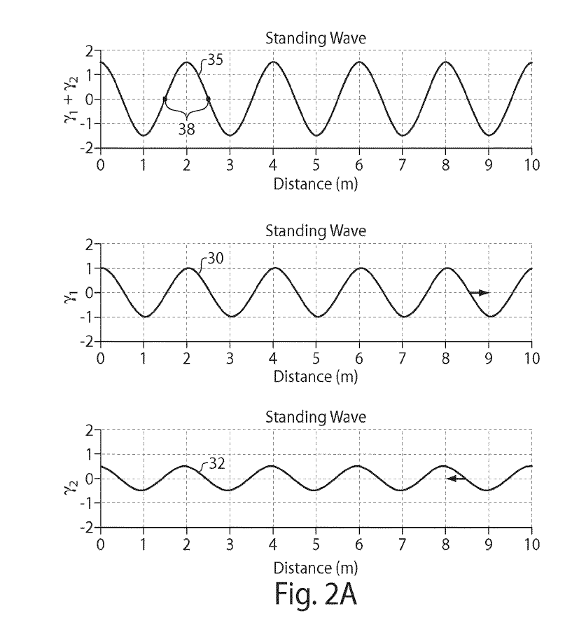

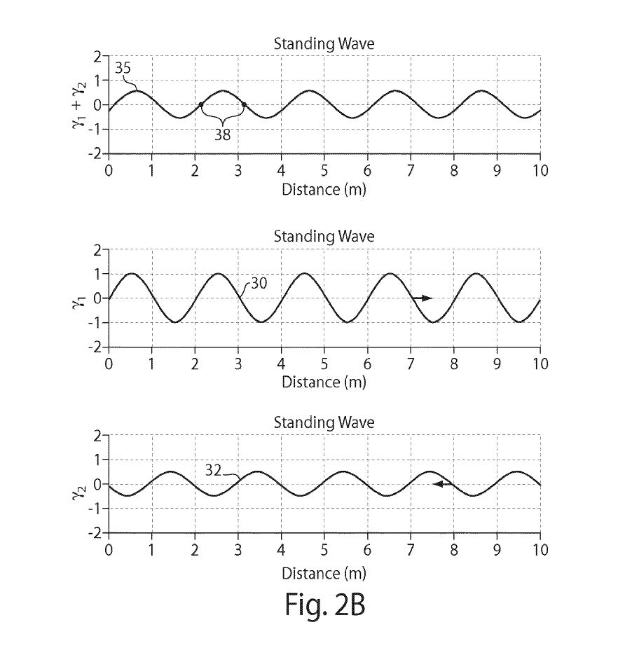

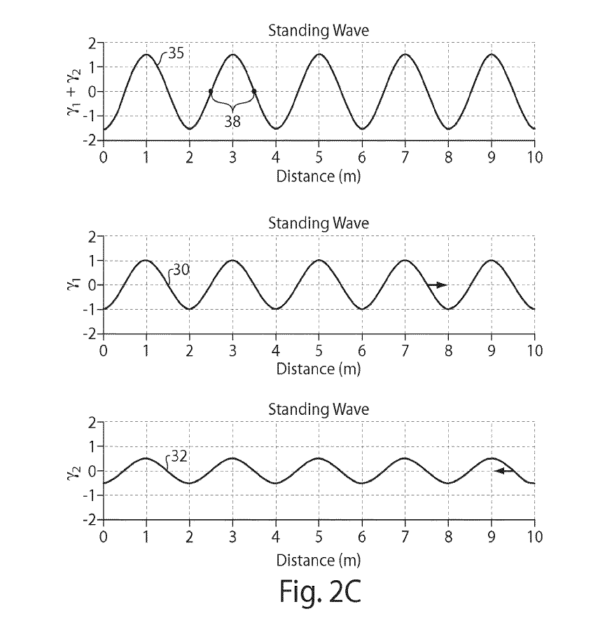

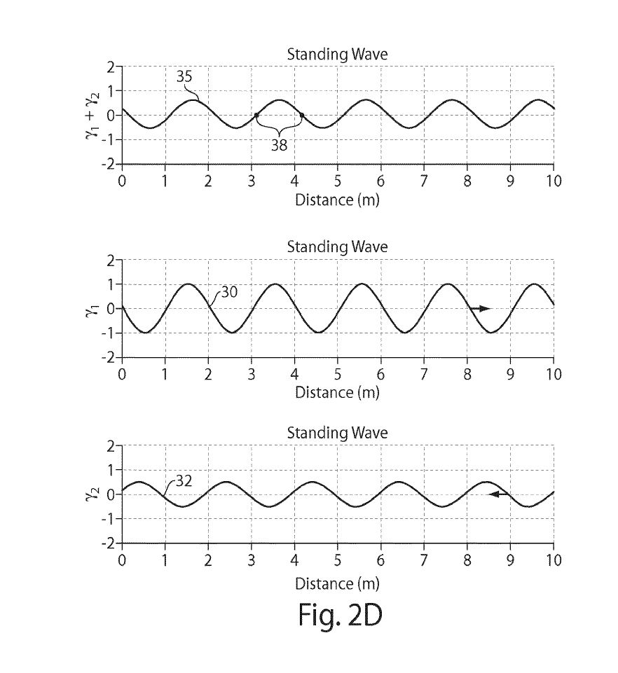

This effect may be seen in FIG. 2. In these figures, wave 30 and wave 32 propagate in opposite directions (wave 30 to the right and wave 32 to the left), leading to their interference as shown by wave 35, which is the superposition of waves 30 and 32. The nodes are identified as points 38, where there is no net displacement owing to the interference of waves 30 and 32. FIGS. 2A, 2B, 2C, and 2D show this system at different points in time. As can be seen in these figures, the location of nodes 38 appears to shift rightward in time, and the average speed that the nodes appear to move is the nodal propagation velocity. (In some embodiments, the nodes may not necessarily appear to move at a constant velocity, so the average velocity that the nodes move is the nodal propagation velocity.)

Referring again to FIG. 1, in some embodiments, the entities may accordingly move due to standing waves created by interference between first acoustic wave 21 and second acoustic wave 22. The entities may be urged to move towards nodal regions 27 (although in some embodiments, some entities may instead move to antinodal regions). In addition, in some cases, nodal regions 27 themselves can be manipulated, e.g., by selecting suitable frequencies of first acoustic wave 21 and second acoustic wave 22 to cause nodal movement to occur, which can be used to move the entities over the surface of substrate 15, for example, in direction 28. Accordingly, by using suitably selected acoustic waves, entities such as particles, cells, droplets, etc. can be manipulated on the surface of a substrate.

The above discussion is a non-limiting example of one embodiment of the present invention that can be used to produce move entities such as particles, cells, droplets, etc. on the surface of a substrate. However, other embodiments are also possible. Accordingly, more generally, various aspects of the invention are directed to various systems and methods for manipulating entities on a surface, e.g., using two (or more) surface acoustic waves.

In one aspect, one, two, or more surface acoustic waves are directed at the surface of a substrate, or at least a portion of the substrate, to manipulate entities that may be present. Entities affected by the surface acoustic waves may be manipulated due to the surface acoustic waves, and based on the properties of the surface acoustic waves. For instance (without wishing to bound by any theory), acoustic waves can also be thought as a type of pressure-based (e.g., compression/decompression) longitudinal waves that propagates through a medium. Entities present in or near the medium may thereby be affected by these waves. Thus, for instance, two (or more) surface acoustic waves may be directed at the surface in a manner such that a standing acoustic wave is generated, e.g., created by interference of the surface acoustic waves. Typically, the surface acoustic waves would have the same frequency. A standing wave typically contains “nodes” or regions with low or no amplitude in oscillation (e.g., of pressure), and “antinodes” where maximum changes in oscillation (e.g., of pressure) occur due to interference of the surface acoustic waves. The presence of such nodes or antinodes, i.e., differences in pressure on the surface, may thus be used to manipulate entities on the surface of the substrate.

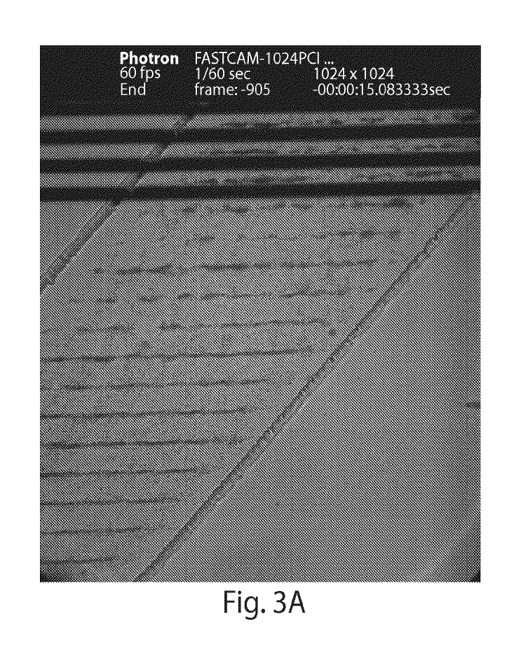

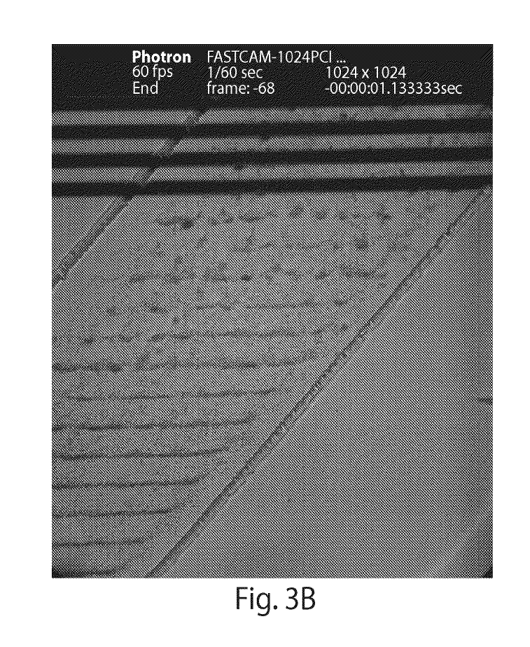

Thus, in some embodiments, the entities present on a surface of a substrate may be manipulated by the surface acoustic waves. For example, the entities may be manipulated due to standing waves, and may be moved around, and/or become aligned, e.g., at the nodes and/or the antinodes. The movement of entities to the nodes or the antinodes may depend on various properties of the entities and/or the fluid containing the entities. For example, alignment of the entities may occur, and may be apparent visually, e.g., as is shown in FIG. 3A.

However, in some embodiments, the frequencies of the surface acoustic waves may not necessarily be equal. In certain cases, mismatches of frequency may cause the nodes of the standing wave to appear to move in time, and this may thereby create a travelling standing wave. By controlling the difference in frequencies of the surface acoustic waves, the apparent average speed of the nodes or the nodal propagation velocity may be controlled, e.g., as was noted above and with reference to FIG. 2. For example, the frequencies of first and second acoustic waves may be selected such that the first surface acoustic wave has a frequency that is within about 20%, within about 15%, within about 10%, or within about 5% of the frequency of a second surface acoustic wave, where the second wave has a lower frequency than the first wave.

Any suitable nodal propagation velocity may be used. For example, the nodal propagation velocity may be between about 1 micrometers/s and about 1 cm/s, between about 1 micrometers/s and about 1 mm/s, between about 1 micrometers/s and about 100 micrometers/s, between about 1 micrometers/s and about 20 micrometers/s, or between about 1 micrometers/s and about 10 micrometers/s.

In one set of embodiments, the first and second acoustic waves may have frequencies selected to create a desired nodal propagation velocity. For instance, the frequencies may be selected such that the nodal propagation velocity is substantially equal to the average velocity of the entities within a fluid, or to the average velocity of the fluid itself. Thus, from the point of view of an entity within a moving fluid, the effect of the travelling standing wave (which appears to be “stationary” with respect to the entity, i.e., since both are moving with substantially the same velocity) is simply to cause alignment of the entities. Accordingly, in some cases, the frequencies may be selected such that the nodal propagation velocity is within about 20%, within about 15%, within about 10%, or within about 5% of the average velocity of the fluid, or the average velocity of a plurality of entities (or vice versa). Thus, for instance, the velocity of the fluid may be the same as, or in the same range as, any of the nodal propagation velocities described herein, e.g., between about 1 micrometers/s and about 1 cm/s, between about 1 micrometers/s and about 1 mm/s, between about 1 micrometers/s and about 100 micrometers/s, between about 1 micrometers/s and about 20 micrometers/s, or between about 1 micrometers/s and about 10 micrometers/s.

The movement of entities to the nodes or the antinodes may depend on various properties of the entities and/or the fluid containing the entities. However, in either case, alignment of the entities may occur, and may be apparent visually, e.g., as is shown in FIGS. 3A-3B. In these example figures, 1 micrometer diameter beads on a surface were subjected to two interfering surface acoustic waves such that many of the beads became aligned. FIG. 3B was acquired a later time point than FIG. 3A, and shows a phase shift of approximately one wavelength relative to FIG. 3A. Thus, in accordance with certain embodiments of the invention, entities on a surface of a substrate may be aligned through application of two (or more) surface acoustic waves.

In one set of embodiments, however, the direction of nodal propagation may not necessarily be exactly the same as the direction of fluid flow on the surface (although in other embodiments, the directions may be the same). In some cases, they are at an angle to each other, e.g., an angle of about 5°, about 10°, about 20°, about 30°, about 40°, about 45°, about 50°, about 60°, about 70°, about 80°, about 90°, about 100°, about 110°, about 120°, about 125°, about 130°, about 140°, about 150°, about 160°, about 170°, or about 180°. Without wishing to be bound by any theory, it is believed that in some cases, a relatively small angle may be useful to minimize acoustic attenuation of the surface acoustic waves by the fluid.

In one set of embodiments, surface acoustic waves are applied and caused to interfere to cause a focusing effect perpendicular (or approximately perpendicular) to the direction of fluid flow. For example, in a channel such as a microfluidic channel, the entities may flow in a first direction but be aligned at an angle relative to the direction of flow. An example may be seen in FIGS. 3A-3B, where beads in a channel are aligned at an angle relative to the channel walls under the influence of the surface acoustic waves.

A surface acoustic wave (“SAW”) is, generally speaking, an acoustic wave able to travel along the surface of a material exhibiting elasticity, with an amplitude that typically decays exponentially with depth into the material. The surface acoustic wave may have any suitable average frequency. For example, the average frequency of the surface acoustic wave may be between about 100 MHz and about 200 MHz, between about 130 MHz and about 160 MHz, between about 140 MHz and about 150 MHz, between about 100 MHz and about 120 MHz, between about 120 MHz and about 140 MHz, between about 140 MHz and about 160 MHz, between about 160 MHz and about 180 MHz, or between about 180 MHz and about 200 MHz or the like, and/or combinations thereof.

Any suitable technique may be used to create a surface acoustic wave. For example, the surface acoustic wave may be created by a generator attached to the surface of a material. In certain embodiments, the surface acoustic wave is created by using an interdigitated electrode or transducer able to convert electrical signals into acoustic waves able to travel along the surface of a material, and in some cases, the frequency of the surface acoustic waves may be controlled by controlling the spacing of the finger repeat distance of the interdigitated electrode or transducer. The surface acoustic waves can be formed on a piezoelectric substrate or other material that may be coupled to a microfluidic substrate at specific locations, e.g., at locations within the microfluidic substrate where alignment is to take place. Suitable voltages (e.g., sinusoidal or other periodically varying voltages) are applied to the piezoelectric substrate, which converts the electrical signals into mechanical vibrations, i.e., surface acoustic waves or sound. The sound is then coupled to the microfluidic substrate, e.g., from the surface of the material. In the microfluidic substrate, the vibrations pass into liquid within microfluidic channels in the microfluidic substrate (e.g., liquid containing droplets containing cells or other entities to be aligned), which give rise to internal streaming within the fluid. Thus, by controlling the applied voltage, streaming within the microfluidic channel may be controlled, which may be used to direct or align entities within the microfluidic channel, e.g., to particular regions within the microfluidic substrate.

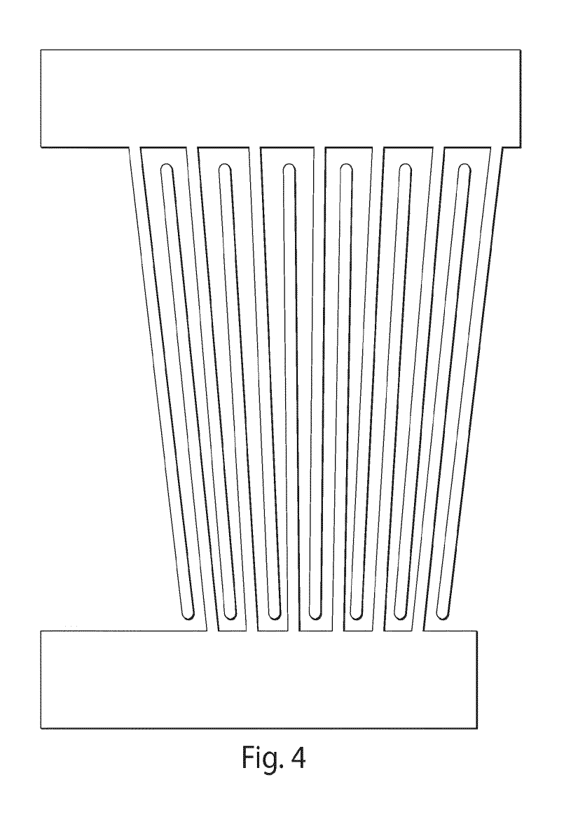

An interdigitated transducer typically comprises one, two, or more electrodes containing a plurality of “fingers” extending away from the electrode, wherein at least some of the fingers are interdigitated. The fingers may be of any length, and may independently have the same or different lengths. The fingers may be spaced on the transducer regularly or irregularly. In some cases, the fingers may be substantially parallel, although in other embodiments they need not be substantially parallel. For example, in one set of embodiments, the interdigitated transducer is a tapered interdigitated transducer. In some cases, the fingers in a tapered interdigitated transducer may be arranged such that the fingers are angled inwardly, e.g., as shown in FIG. 4. The interdigitated electrode typically includes of two interlocking comb-shaped metallic electrodes that do not touch, but are interdigitated. A schematic example of such an electrode is illustrated in FIG. 4. The electrodes may be formed from any suitable electrode material, for example, metals such as gold, silver, copper, nickel, or the like. The operating frequency of the interdigitated electrode may be determined, in some embodiments, by the ratio of the sound velocity in the substrate to twice the finger spacing. For instance, in one set of embodiments, the finger repeat distance may be between about 10 micrometers and about 40 micrometers, between about 10 micrometers and about 30 micrometers, between about 20 micrometers and about 40 micrometers, between about 20 micrometers and about 30 micrometers, or between about 23 micrometers and about 28 micrometers.

The interdigitated electrode may be positioned on a piezoelectric substrate, or other material able to transmit surface acoustic waves, e.g., to a coupling region. The piezoelectric substrate may be formed out of any suitable piezoelectric material, for example, quartz, lithium niobate, lithium tantalate, lanthanum gallium silicate, etc. In one set of embodiments, the piezoelectric substrate is anisotropic, and in some embodiments, the piezoelectric substrate is a Y-cut LiNbO₃ material.

The microfluidic substrate may be any suitable substrate which contains or defines one or more microfluidic channels. For instance, as is discussed below, the microfluidic substrate may be formed out of polydimethylsiloxane, polytetrafluoroethylene, or other suitable elastomeric polymers, at least according to various non-limiting examples. In certain embodiments, the substrate contains at least an inlet channel, a first (outlet) channel, and a second (outlet) channel meeting at a junction, e.g., having a “Y” or a “T” shape. By suitable application of surface acoustic waves, droplets contained within a fluid flowing through the inlet channel may be directed into the first channel or second channel. In other embodiments, however, other configurations of channels and junctions may be used, e.g., as described herein. Droplets contained within microfluidic channels are discussed in detail below.

The piezoelectric substrate may be activated by any suitable electronic input signal or voltage to the piezoelectric substrate (or portion thereof). For example, the input signal may be one in which a periodically varying signal is used, e.g., to create corresponding acoustic waves. For instance, the signals may be sine waves, square waves, sawtooth waves, triangular waves, or the like. The frequency may be for example, between about 50 Hz and about 100 KHz, between about 100 Hz and about 2 kHz, between about 100 Hz and about 1,000 Hz, between about 1,000 Hz and about 10,000 Hz, between about 10,000 Hz and about 100,000 Hz, or the like, and/or combinations thereof. In some cases, the frequency may be at least about 50 Hz, at least about 100 Hz, at least about 300 Hz, at least about 1,000 Hz, at least about 3,000 Hz, at least about 10,000 Hz, at least about 30,000 Hz, at least about 100,000 Hz, at least about 300,000 Hz, at least about 1 MHz, at least about 3 MHz, at least about 10 MHz, at least about 30 MHz, at least about 100 MHz, at least about 300 MHz, or at least about 1 GHz or more in some embodiments. In certain instances, the frequency may be no more than about 1 GHz, no more than about 300 MHz, no more than about 100 MHz, no more than about 30 MHz, no more than about 10 MHz, no more than about 3 MHz, no more than about 1 MHz, no more than about 300,000 Hz, no more than about 100,000 Hz, no more than about 30,000 Hz, no more than about 10,000 Hz, no more than about 3,000 Hz, no more than about 1,000 Hz, no more than about 300 Hz, no more than about 100 Hz, or the like.

The interdigitated electrode may be positioned on the piezoelectric substrate (or other suitable material) such that acoustic waves produced by the interdigitated electrodes are directed at a region of acoustic coupling between the piezoelectric substrate and the microfluidic substrate. For example, the piezoelectric substrate and the microfluidic substrate may be coupled or physically bonded to each other, for example, using ozone plasma treatment, or other suitable techniques. In some cases, the rest of the piezoelectric substrate and the microfluidic substrate are at least acoustically isolated from each other, and in certain embodiments, the piezoelectric substrate and the microfluidic substrate are physically isolated from each other. Without wishing to be bound by any theory, it is believed that due to the isolation, acoustic waves created by the interdigitated electrode and the piezoelectric substrate do not affect the microfluidic substrate except at regions where alignment is generally desired, e.g., at one or more coupling regions.

In one set of embodiments, the coupling region of the piezoelectric substrate and the microfluidic substrate is located within or proximate the location where droplets or other entities are to be aligned within the microfluidic substrate. Thus, for instance, the coupling region may be positioned within or at least near a junction between an inlet microfluidic channel, and two or more outlet microfluidic channels, such that acoustic waves transmitted into the microfluidic substrate through the coupling region are at least sufficient to affect liquid streaming within the microfluidic channels, and in some embodiments such that alignment of droplets or other entities is able to occur. In one set of embodiments, there may be three, four, five, or more outlet microfluidic channels, and in some embodiments the alignment of droplets or other entities into the two or more outlet microfluidic channels may be controlled by controlling the surface acoustic waves, e.g., by applying suitable voltages to the piezoelectric substrate, as discussed herein. The coupling region may have any suitable shape and/or size. In one set of embodiments, the coupling region is sized to be contained within a microfluidic channel. The coupling region may be round, oval, or have other shapes, depending on the embodiment. In some cases, two, three, or more coupling regions may be used.

In some embodiments, a tapered interdigitated transducer may be used to create a surface acoustic wave. A tapered interdigitated transducer may allow relatively high control of the location at which a SAW is applied to a channel, in contrast to an interdigitated transducer where all of the fingers are parallel to each other and the spacing between electrodes is constant. Without wishing to be bound by any theory, it is believed that the location which a SAW can be applied by an interdigitated transducer is controlled, at least in part, by the spacing between the electrodes. By controlling the potential applied to the interdigitated transducer, and thereby controlling the resonance frequency of the applied SAW, the position and/or the strength of the SAW as applied by the interdigitated transducer may be correspondingly controlled. Thus, for example, applying a first voltage to an interdigitated transducer may cause a first resonance frequency of the resulting SAW to be applied (e.g., within a channel), while applying a second voltage may cause a second resonance frequency of the resulting SAW to be applied to a different location (e.g., within the channel). As another example, a plurality of coupling regions may be used, e.g., in combination with one or more tapered interdigitated transducers, to control the exact location and nature of deflection of a droplet, e.g., to direct the droplet to two, three, or more channels.

As mentioned, in some cases, the entities may be suspended or carried in a fluid, and in some embodiments, the fluid may move at an average velocity. The entities themselves may also move at an average velocity, which may or may not be equal to the average velocity of the fluid. Non-limiting examples of entities include particles, beads, cells, droplets, or the like. In some cases, more than one entity or type of entity may be present. For example, a surface may include both cells and droplets, e.g., separately or combined together (for example, the droplets may include one or more cells).

The entities may be spherical or non-spherical, and may have any suitable average diameter. Multiple entities can be present in some cases, and they may independently have the same or different average diameters. The “average diameter” of a population of entities is the arithmetic average of the diameters of the entities. Those of ordinary skill in the art will be able to determine the average diameter of a population of entities, for example, using laser light scattering or other known techniques. The diameter of an entity, in a non-spherical entity, is the mathematically-defined average diameter of the entity, integrated across the entire surface. As non-limiting examples, the average diameter of an entity may be less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers in some cases. The average cross-sectional diameter may also be at least about 1 micrometer, at least about 2 micrometers, at least about 3 micrometers, at least about 5 micrometers, at least about 10 micrometers, at least about 15 micrometers, or at least about 20 micrometers in certain cases. In some embodiments, at least about 50%, at least about 75%, at least about 90%, at least about 95%, or at least about 99% of the droplets within a plurality of droplets has an average cross-sectional diameter within any of the ranges outlined in this paragraph.

In some cases, the entities may be substantially monodisperse, or have a homogenous distribution of diameters, i.e., the entities may have a distribution of diameters such that no more than about 10%, about 5%, about 3%, about 1%, about 0.03%, or about 0.01% of the droplets have an average diameter greater than about 10%, about 5%, about 3%, about 1%, about 0.03%, or about 0.01% of the average diameter of the droplets.

Typically, the fluid containing the entities is a liquid (for example, water), although other types of fluids may also be present in some embodiments, e.g., free-flowing solid particles, viscoelastic materials. The fluid may be any substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits flow.

In some embodiments, the fluid may be hydrophilic (or aqueous), hydrophobic (or an “oil”). Typically, a “hydrophilic” fluid is one that is miscible with pure water, while a “hydrophobic” fluid is a fluid that is not miscible with pure water. It should be noted that the term “oil,” as used herein, merely refers to a fluid that is hydrophobic and not miscible in water. Thus, the oil may be a hydrocarbon in some embodiments, but in other embodiments, the oil may be (or include) other hydrophobic fluids (for example, octanol). It should also be noted that the hydrophilic or aqueous fluid need not be pure water. For example, the hydrophilic fluid may be an aqueous solution, for example, a buffer solution, a solution containing a dissolved salt, or the like. A hydrophilic fluid may also be, or include, for example, ethanol or other liquids that are miscible in water, e.g., instead of or in addition to water.

As mentioned, in some, but not all embodiments, the systems and methods described herein may include one or more microfluidic components, for example, one or more microfluidic channels. “Microfluidic,” as used herein, refers to a device, apparatus or system including at least one fluid channel having a cross-sectional dimension of less than 1 mm, and a ratio of length to largest cross-sectional dimension of at least 3:1. A “microfluidic channel,” as used herein, is a channel meeting these criteria. The “cross-sectional dimension” of the channel is measured perpendicular to the direction of fluid flow within the channel. Thus, some or all of the fluid channels in microfluidic embodiments of the invention may have maximum cross-sectional dimensions less than 2 mm, and in certain cases, less than 1 mm. In one set of embodiments, all fluid channels containing embodiments of the invention are microfluidic or have a largest cross sectional dimension of no more than 2 mm or 1 mm. In certain embodiments, the fluid channels may be formed in part by a single component (e.g. an etched substrate or molded unit). Of course, larger channels, tubes, chambers, reservoirs, etc. can be used to store fluids and/or deliver fluids to various components or systems of the invention. In one set of embodiments, the maximum cross-sectional dimension of the channel(s) containing embodiments of the invention is less than 500 microns, less than 200 microns, less than 100 microns, less than 50 microns, or less than 25 microns.

A “channel,” as used herein, means a feature on or in an article (substrate) that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

In one set of embodiments, the fluidic droplets may contain cells or other entities, such as proteins, viruses, macromolecules, particles, etc. As used herein, a “cell” is given its ordinary meaning as used in biology. The cell may be any cell or cell type. For example, the cell may be a bacterium or other single-cell organism, a plant cell, or an animal cell. If the cell is a single-cell organism, then the cell may be, for example, a protozoan, a trypanosome, an amoeba, a yeast cell, algae, etc. If the cell is an animal cell, the cell may be, for example, an invertebrate cell (e.g., a cell from a fruit fly), a fish cell (e.g., a zebrafish cell), an amphibian cell (e.g., a frog cell), a reptile cell, a bird cell, or a mammalian cell such as a primate cell, a bovine cell, a horse cell, a porcine cell, a goat cell, a dog cell, a cat cell, or a cell from a rodent such as a rat or a mouse. If the cell is from a multicellular organism, the cell may be from any part of the organism. For instance, if the cell is from an animal, the cell may be a cardiac cell, a fibroblast, a keratinocyte, a heptaocyte, a chondracyte, a neural cell, a osteocyte, a muscle cell, a blood cell, an endothelial cell, an immune cell (e.g., a T-cell, a B-cell, a macrophage, a neutrophil, a basophil, a mast cell, an eosinophil), a stem cell, etc. In some cases, the cell may be a genetically engineered cell. In certain embodiments, the cell may be a Chinese hamster ovarian (“CHO”) cell or a 3T3 cell.

A variety of materials and methods, according to certain aspects of the invention, can be used to form any of the above-described components of the systems and devices of the invention. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming microfluidic structures of the invention (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

In one embodiment, a bottom wall is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, thermal bonding, solvent bonding, ultrasonic welding, etc.

The following documents are incorporated herein by reference: U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007; U.S. patent application Ser. No. 08/131,841, filed Oct. 4, 1993, entitled “Formation of Microstamped Patterns on Surfaces and Derivative Articles,” by Kumar, et al., now U.S. Pat. No. 5,512,131, issued Apr. 30, 1996; priority to International Patent Application No. PCT/US96/03073, filed Mar. 1, 1996, entitled “Microcontact Printing on Surfaces and Derivative Articles,” by Whitesides, et al., published as WO 96/29629 on Jun. 26, 1996; U.S. patent application Ser. No. 09/004,583, filed Jan. 8, 1998, entitled “Method of Forming Articles Including Waveguides via Capillary Micromolding and Microtransfer Molding,” by Kim, et al., now U.S. Pat. No. 6,355,198, issued Mar. 12, 2002; International Patent Application No. PCT/US01/16973, filed May 25, 2001, entitled “Microfluidic Systems including Three-Dimensionally Arrayed Channel Networks,” by Anderson, et al., published as WO 01/89787 on Nov. 29, 2001; U.S. Provisional Patent Application Ser. No. 60/392,195, filed Jun. 28, 2002, entitled “Multiphase Microfluidic System and Method,” by Stone, et al.; U.S. Provisional Patent Application Ser. No. 60/424,042, filed Nov. 5, 2002, entitled “Method and Apparatus for Fluid Dispersion,” by Link, et al.; U.S. Provisional Patent Application Ser. No. 60/461,954, filed Apr. 10, 2003, entitled “Formation and Control of Fluidic Species,” by Link, et al.; International Patent Application No. PCT/US03/20542, filed Jun. 30, 2003, entitled “Method and Apparatus for Fluid Dispersion,” by Stone, et al., published as WO 2004/002627 on Jan. 8, 2004; U.S. Provisional Patent Application Ser. No. 60/498,091, filed Aug. 27, 2003, entitled “Electronic Control of Fluidic Species,” by Link, et al.; International Patent Application No. PCT/US2004/010903, filed Apr. 9, 2004, entitled “Formation and Control of Fluidic Species,” by Link, et al., published as WO 2004/091763 on Oct. 28, 2004; International Patent Application No. PCT/US2004/027912, filed Aug. 27, 2004, entitled “Electronic Control of Fluidic Species,” by Link, et al., published as WO 2005/021151 on Mar. 10, 2005; U.S. patent application Ser. No. 11/024,228, filed Dec. 28, 2004, entitled “Method and Apparatus for Fluid Dispersion,” by Stone, et al., published as U.S. Patent Application Publication No. 2005-0172476 on Aug. 11, 2005; U.S. Provisional Patent Application Ser. No. 60/659,045, filed Mar. 4, 2005, entitled “Method and Apparatus for Forming Multiple Emulsions,” by Weitz, et al.; U.S. Provisional Patent Application Ser. No. 60/659,046, filed Mar. 4, 2005, entitled “Systems and Methods of Forming Particles,” by Garstecki, et al.; U.S. patent application Ser. No. 11/246,911, filed Oct. 7, 2005, entitled “Formation and Control of Fluidic Species,” by Link, et al.; and International Patent Application No. PCT/US2011/048804, filed Aug. 23, 2011, entitled “Acoustic Waves in Microfluidics,” by Weitz, et al.

### Example 1

In this example, alignment of beads in accordance with an embodiment of the invention is shown with reference to FIGS. 3A-3B. Initially, a polydimethylsiloxane (PDMS) channel was directly placed on top of a LiNbO₃ substrate. The channel had a width of 500 micrometers and a height of 50 micrometers.

Two interdigitated transducers (IDTs) were used to apply surface acoustic waves (SAWs) to the channel. The electrode finger distance of the IDTs was 25 micrometers and the finger width was 25 micrometers, corresponding to a wavelength of 100 micrometers. The two IDTs were separated by a distance of 1 mm. Two couple frequency generators were used to drive the IDTs. The working frequency was 38 MHz.

The fluid used in this example was pure water, although other fluids such as sodium chloride solutions, etc., could have been used in other cases. The beads were polystyrol beads. In various experiments, the beads used ranged in diameter from 1 micrometer to 20 micrometers. Nodal propagation velocities and fluid velocities were in a range from 1 micrometer/s to several 100 micrometers/s. Higher velocities, e.g., up to several mm/s to cm/s may also be possible in other cases.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
providing a plurality of entities in a fluid flowing at an average fluid velocity; and
aligning at least some of the entities by applying a first acoustic wave and a second acoustic wave to at least a portion of the fluid, wherein the first acoustic wave and the second acoustic wave interfere to create a standing acoustic wave having a nodal propagation velocity within about 20% of the average fluid velocity.

2. The method of claim 1, wherein at least some of the plurality of entities are droplets.

3. The method of claim 2, wherein the droplets are substantially monodisperse.

4. The method of any one of claim 2 or 3, wherein at least some of the droplets are substantially immiscible in the fluid.

5. The method of any one of claims 1-4, wherein at least some of the plurality of entities are particles.

6. The method of any one of claims 1-5, wherein at least some of the plurality of entities are cells.

7. The method of any one of claims 1-6, wherein at least some of the plurality of entities comprise cells.

8. The method of any one of claims 1-7, wherein the first acoustic wave has an average frequency of between about 130 MHz and about 160 MHz.

9. The method of any one of claims 1-8, wherein the first acoustic wave has an average frequency of between about 140 MHz and about 150 MHz.

10. The method of any one of claims 1-9, wherein the first acoustic wave and the second acoustic wave interfere to create a standing acoustic wave having a nodal propagation velocity within about 10% of the average fluid velocity.

11. The method of any one of claims 1-10, wherein the fluid is a liquid.

12. The method of any one of claims 1-11, wherein the nodal propagation velocity is between about 1 micrometers/s and about 10 cm/s.

13. The method of any one of claims 1-12, wherein the nodal propagation velocity is between about 1 micrometers/s and about 1 cm/s.

14. The method of any one of claims 1-13, wherein the nodal propagation velocity is between about 1 micrometers/s and about 1 mm/s.

15. The method of any one of claims 1-14, wherein the nodal propagation velocity is between about 1 micrometers/s and about 100 micrometers/s.

16. The method of any one of claims 1-15, wherein the nodal propagation velocity is between about 1 micrometers/s and about 20 micrometers/s.

17. The method of any one of claims 1-16, wherein the entities have an average diameter of less than about 5 micrometers.

18. An apparatus, comprising:
a piezoelectric substrate;
a plurality of entities suspended in a fluid disposed proximate the piezoelectric substrate;
a first acoustic wave generator able to direct first acoustic waves at a target region of the piezoelectric substrate; and
a second acoustic wave generator able to direct second acoustic waves at the target region of the piezoelectric substrate.

19. The apparatus of claim 18, wherein the first acoustic wave generator comprises one or more interdigitated transducers.

20. The apparatus of claim 19, wherein at least one of the one or more interdigitated transducers has a finger spacing of between about 20 micrometers and about 30 micrometers.

21. The apparatus of any one of claim 19 or 20, wherein at least one of the one or more interdigitated transducers is a tapered interdigitated transducer.

22. The apparatus of any one of claims 19-21, wherein at least one of the one or more interdigitated transducers comprises a first electrode and a second electrode that are interdigitated with each other.

23. The apparatus of any one of claims 18-22, wherein the piezoelectric substrate comprises LiNbO₃.

24. The apparatus of any one of claims 18-23, wherein the microfluidic substrate comprises polydimethylsiloxane.

25. A method, comprising:
determining an average velocity of plurality of entities suspended in a fluid; and
applying a first acoustic wave and a second acoustic wave to at least a portion of the fluid, wherein the first acoustic wave and the second acoustic wave have frequencies selected to interfere to create a standing acoustic wave having a nodal propagation velocity within 20% of the average velocity.
